(19) United States
(12) Patent Application Publication
(10) Pub. No.: US 2002/0058230 A1
(43) Pub. Date: May 16, 2002

(54) Illuminated dental examination and treatment device

(76) Inventors: Gavriel Savin, Rishon LeZion (IL); Ron Reisman, Tel-Aviv (IL); Nachman Berger, Givatayim (IL)

Correspondence Address: EDWARD LANGER, B.S.E.F., M.B.A., J.D., ADVOCATE & PATENT ATTORNEY, 312 GIRON CENTER, P.O.B. 410, BAANANA, 43103, IL

(21) Appl. No.: 09/899,546

(22) Filed: Jul. 6, 2001

Related U.S. Application Data
(60) Provisional application No. 60/216,909, filed on Jul. 6, 2000.

(51) Int. Cl. A61C 3/00; A61C 1/00

(52) U.S. Cl. 433/31; 433/29

(57) ABSTRACT

A device comprising a universal light-adapter suitable for use with a wide variety of dental mirrors. The body of the adapter is a tubular structure, closed on one end, into which the handle of an ordinary dental mirror may be inserted and secured in place. Mounted at the forward end of the adapter is a lighting element comprising a light bulb and pressure switch conveniently positioned to operate the light. The light bulb throws a beam of light onto the dental mirror, providing greater visibility to the dentist at the time of treatment or examination. The power for the device is provided by a rechargeable battery in the lower part of the tubular structure and appropriately connected to the light bulb and pressure switch. The whole device is insertable into a convenient stand when not in use, which also serves to house a charger unit for recharging the battery supply.

### FIELD OF THE INVENTION

The present invention relates to devices for medical examination and treatment, and more particularly, to a device for enabling illuminated dental examination and treatment.

### BACKGROUND OF THE INVENTION

In dentistry it has been the practice to use a dental lamp in combination with a dental mouth mirror to assist viewing while performing work in the oral cavity. The dental lamp is a light source providing a wide beam of light, which may be focused on the general area of a patient's mouth. Thereafter, a dental mirror is used to indirectly view inaccessible areas of the mouth or to retract the tongue or cheek in order to inspect an area indirectly. Such a technique is not entirely satisfactory. A dentist's hands or instrument often shade an area which is being examined, thereby requiring the dentist to assume an awkward position so as not to view the otherwise shaded area during an oral examination or dental cleaning. Where each tooth and various other structures in the oral cavity are observed and manipulated, the dental lamp must be constantly readjusted, resulting in considerable time loss and frustration. In order to concentrate the light further, or to get an enlarged image, one can use a mirror with a concave-reflecting surface. Furthermore, an overhead light requires frequent adjustment, which increases the danger of contamination.

After use with a patient, the handheld dental mirror is autoclaved to sterilize it to prevent infection and contamination of the next patient for whom it may be used. Although dental personnel now typically wear gloves, mouth masks, and even goggles to avoid infectious diseases, this mainly protects the dental personnel and only indirectly protects each patient. If an overhead lamp is used for illumination, the redirection or refocusing of this lamp requires hand contact by the dental person, and this can lead to cross-contamination of patients. In order to minimize this problem, a variety of handle covers have been devised and commercialized, including plastic sheaths, replaceable handles, and the like.

Other prior art include U.S. Pat. No. 5,139,421, which provides a mirror to be used in combination with a light source. Light is transmitted from the light source through the body of a light conductive shank to a shank hell and face, from which illumination is provided in front of and behind the mirror head. This invention can be used with a fiber optic lighting system. The source of the light and the manner in which the light is transmitted to the area to be examined differ from that used in the present invention

U.S. Pat. No. 4,907,135 provides a dental mirror flashlight unit. The problem with both this and the former inventions is that they are expensive and a dental user when purchasing one unit cannot use it for repetitive use for other patients unless it can be sterilized. Since this is not so simple to do, neither of these prior art inventions can be efficiently used in a clinical dental setting for routine work.

U.S. Pat. No. 5,636,984 to Gomes provides a dental inspection device comprising a handle, an encapsulated light bulb and a battery power unit contained in the handle. The lower portion is discarded after use. The problem with this prior art is that the mirror is integral to the device and not universally adaptable for any existing dental mirrors. Also, the Gomes device is inherently bulky to handle and relatively expensive.

U.S. Pat. No. 6,030,210 to Bianchetti provides for another type of dental hand instrument incorporating a light source. This prior art includes a hydraulic connector making it a somewhat complex device and consequently also expensive to use. The device functions as a vibrator for removal of tartar and plaque from the tooth surface and only incidentally as a lighting tool for general dental use.

When a dentist wishes to explain to a patient what treatment is required, such as replacing an old filling or making a new filling, the patient will hold an ordinary hand mirror and the dentist, using a conventional overhead light and an ordinary dental mirror, will show the patient the treatment site by reflecting the image of the dental mirror into the hand mirror. In many such cases, the hand mirror blocks the light entering from above, preventing the treatment site from being seen.

Root canal treatments are carried out daily in dental clinics, both by general dentists and by endodontists specializing in these treatments. The need for root canal treatment occurs when bacterial infection in the tooth pulp causes inflammation. In such a case, the decayed material must be removed immediately from within the tooth canal and the cavity must be thoroughly cleaned of all remnants of bacterial material. Afterwards, the cavity must be filled with a rubber-like, inert material (called Gutta Percha). At the time of the treatment, the dentist must have good vision of the canal he is treating, in order to satisfactorily determine whether all of the nerve material within the tooth pulp has been cleaned and whether the Gutta Percha has been properly positioned. For that purpose, the dentist is aided by external lighting, which frequently is not sufficient at certain positions and angles.

When a severe bacterial infection is revealed in one of the rear teeth (especially in wisdom teeth), the preferred solution frequently is surgical extraction of the tooth. During this treatment, the dentist must use maximum care when cutting out and extracting the tooth, as well as when stitching the gums after the tooth has been extracted. Since the teeth involved are the rear ones, the visibility provided by external lighting is generally low, a situation which complicates and lengthens the treatment.

In a tooth wherein root treatment is carried out, a situation is possible where severe periapical lesion will be revealed underneath the root. Such a situation requires a surgical operation including raising the surgical flap, drilling of the bone and excision of the lesion. Carrying out such an operation requires light within a deep canal, which is not possible with existing systems of external lighting.

### SUMMARY OF THE INVENTION

Accordingly, it is a principal object of the present invention to overcome the above disadvantages and drawbacks of the prior art by providing a device enabling a dentist to transform any dental mirror into an illuminated one, thereby providing a dentist with better visibility when carrying out examinations and different treatments of the teeth and making these examinations and treatments safer, more efficient, and more comfortable both for the patient and the dentist.

The present invention, hereinafter called “ULA” (Universal Light Adapter), is a tool intended to be used mainly by dentists and is a valuable aid to the dentist during examination and various treatments of the teeth. Actually, it can be said that the ULA can assist the dentist in any type of treatment of the teeth, beginning with an ordinary examination and ending with the most difficult and complicated treatments (as mentioned above).

The ULA is a breakthrough in the field of dental medicine. Therefore, this device answers a true and tested need. It is important to emphasize that the ULA is a unique dental product and that today there is not even one competing product in the world market.

It is an object of the invention is to provide a relatively inexpensive tool, which can be used routinely and hygienically by dental professionals.

Yet a further object of the invention is to provide a tool for use by the general public as a self-examination device of the oral and dental tissue, in particular, and for other personal uses requiring an illuminated examination tool.

Thus there is provided a device for enabling illuminated dental examination and treatment comprising: an elongated, rigid structure open at the forward portion to receive and accommodate a variety of handles of dental mirrors, and closed at the distal end with an end cap; a lighting element including a light source and switch mounted on the forward portion of the rigid structure; and an integral power supply encased in the rigid structure adjacent to the end cap for providing electrical power to the light source.

Other features and advantages of the present invention will become clear from the further detailed description and examples.

### BRIEF DESCRIPTION OF THE DRAWINGS

For a better understanding of the invention with regard to the embodiments thereof, reference is made to the accompanying drawings and description, in which like numerals designate corresponding elements or sections throughout, and in which:

FIGS. 1A and 1B are general orthographic views of a ULA device in accordance with an embodiment of the invention;

FIGS. 2A and 2B are cutaway views of the ULA showing the relative location of components in a side view 2A, and another general view 2B, respectively; and

FIG. 3 depicts the invention stored upright in a holder stand which also serves as a charger unit for the ULA rechargeable power supply.

### DETAILED DESCRIPTION OF THE INVENTION

The invention will now be described in connection with certain preferred embodiments with reference to the following illustrative figures so that it may be more fully understood. References to like numbers indicate like components in all of the figures.

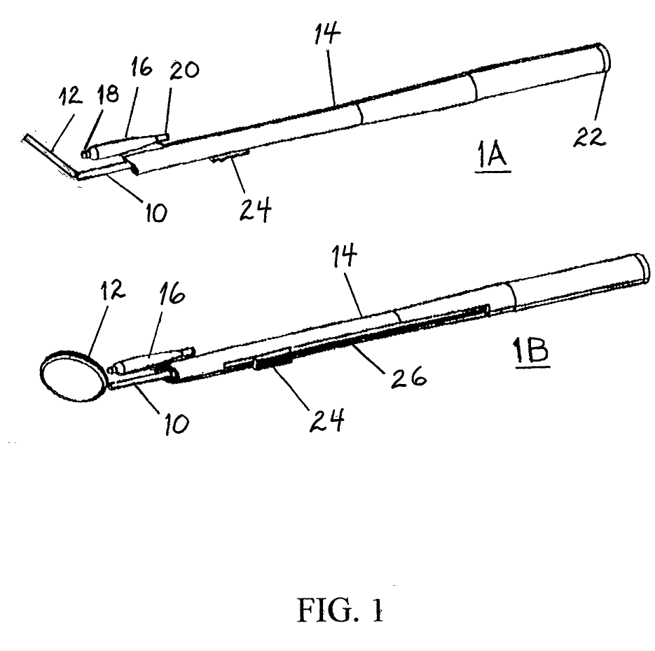

FIGS. 1A and 1B are general views of a ULA device in accordance with an embodiment of the invention.

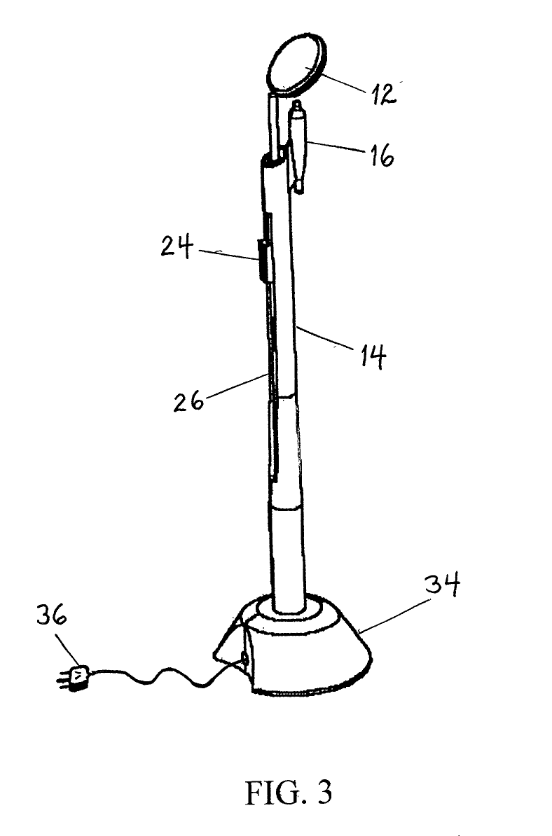

FIG. 1A is a general side view showing major features of the ULA. The tool handle 10 of a dental examination mirror 12 is shown inserted into hollow ULA handle 14. Projecting from the forward end of ULA handle 14 is a lighting element 16 comprising a light source 18 and a pressure switch 20 for activating light source 18. Lighting element 16 is constructed in such a way as to concentrate the light beam from light source 18 towards the focus of mirror 12, increasing its efficiency. Pressure switch 20 is advantageously placed so that when a dentist positions mirror 12 in the customary manner, ULA handle 14 easily and comfortably accommodates finger placement on pressure switch 20. ULA handle 14 serves as the body of the device, which can be made of ABS plastic, or any similar material known to those skilled in the art, and, in a preferred embodiment, is comprised of two sections which are ultrasonically welded together. The distal portion of the ULA device is designed as a end cap 22 upon which to rest the ULA device when not in use. End cap 22 is provided with electrical contacts for convenient recharging of the ULA power supply when placed in an appropriate charger unit (see FIG. 3).

FIG. 1B is another general view of the ULA device showing further construction details. Tool handle 10 of dental mirror 12 is locked into place or released from the ULA handle 14 using a sliding locking mechanism 24 easily operable by a simple finger motion in a longitudinal direction, forward or rearward, respectively. An access opening 26 is provided for ease in cleaning the hollow space within ULA handle 14 when the tool handle 10 of mirror 12 has been released and removed from the ULA.

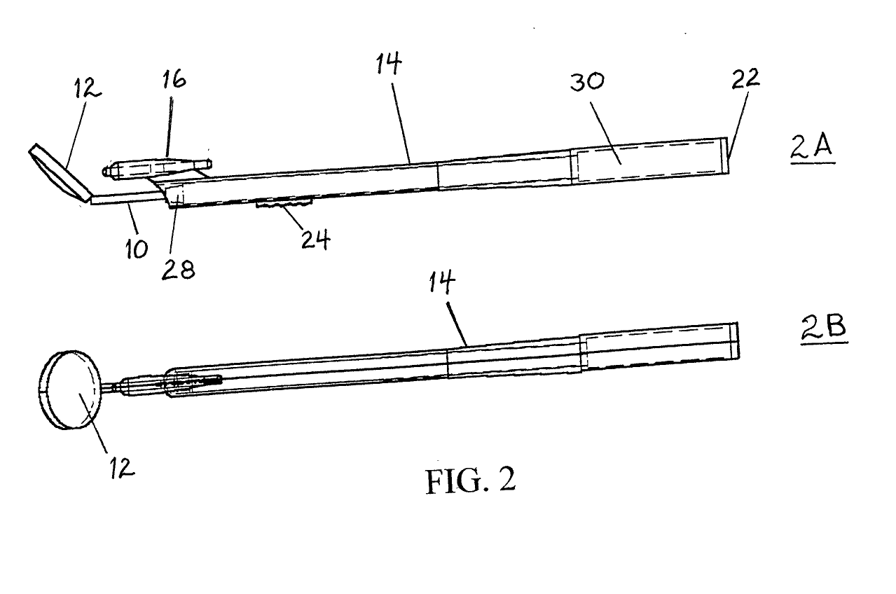

FIGS. 2A and 2B are cutaway views of the ULA showing the relative location of components in a side view 2A, and another general view 2B, respectively.

FIG. 2A is a cutaway side view of a ULA depicting the location of the tool holder 28 for holding in place a tool handle 10 of a typical dental mirror 12 inserted into ULA handle 14. Tool holder 28 can conform itself to hold any type of dental mirror on the market, so that a dentist can use the ULA together with the dental mirror to which he or she is accustomed.

In the embodiment of the invention described in relation to FIGS. 1 and 2, a built-in rechargeable battery (not shown) is utilized and this is accommodated in the distal portion of the hollow interior of ULA handle 14 in a battery compartment 30 in close proximity to the end cap 22 of the ULA. The battery is appropriately connected to the components of lighting element 16. Since the lifetime of a rechargeable battery is estimated to be about 3.5 years, the ULA should be replaced when the battery is no longer rechargeable.

FIG. 2B is a top cutaway view of the ULA depicting the electrical connection 32 extending from the end cap 22 to the lighting element 16.

FIG. 3 depicts the ULA device stored upright in a stand in accordance with an embodiment of the invention. Stand 34 houses a battery charger (not shown) for recharging the battery powering the ULA device. When not in use, the ULA device is inserted into stand 34 so that end cap 22 (see FIGS. 1 and 2) is in direct electrical contact with the charger unit. The battery charger housed in stand 34 is provided with a standard AC electrical cord and plug 36.

Storing and charging the ULA in a vertical position enables a dentist to easily and quickly pick up and set down the ULA during examination of a patient without worrying about the possible contact of the dental mirror 12 with non-sterile surfaces, etc. This orientation for the stored ULA device also has the advantage of taking up less surface space among a dentist's many other tools needed close at hand during treatment or examination sessions. For treatment or examination of a subsequent patient, a dentist can quickly release and remove the mirror's tool handle 10 from the ULA handle 14 by finger action on the sliding locking mechanism 24. This enables the dentist to sterilize the mirror 12 in a standard autoclave according to accepted medical/dental practice.

Having described the present invention with regard to certain specific embodiments thereof, it is to be understood that the description is not meant as a limitation, since further modifications may now suggest themselves to those skilled in the art, and it is intended to cover such modifications as fall within the scope of the above-described invention.

We claim:

1. A device for enabling illuminated dental examination and treatment, said device comprising:
an elongated, rigid structure open at the forward portion to receive and accommodate a variety of handles of dental mirrors, and closed at the distal end with an end cap;
a lighting element including a light source and switch mounted on the forward portion of said rigid structure; and
an integral power supply encased in said rigid structure adjacent to said end cap for providing electrical power for said light source.

2. The device as claimed in claim 1, wherein said rigid structure is tubular and comprises the body of said device.

3. The device as in claim 2, wherein said body is comprised of an open forward end provided with protuberances which conform themselves to a variety of dental mirrors inserted therein so as to retain said mirrors in a fixed position in relation to said body.

4. The device as claimed in claim 2, wherein said body is tapered for use as a handle.

5. The device as claimed in claim 1, wherein said device is composed of any material suitable for use in medical devices involving human subjects.

6. The device as claimed in claim 5, wherein said material is ABS plastic.

7. The device as claimed in claim 1, wherein said light source comprises a small, conventional light bulb

8. The device as in claim 7, wherein said light bulb is positioned in relation to a dental mirror so as to direct a beam of light into the focal point of said mirror.

9. The device as claimed in claim 1, wherein said switch comprises a pressure switch.

10. The device as claimed in claim 1, wherein said power supply is a battery.

11. The device as claimed in claim 10, wherein said battery is rechargeable.

12. The device as claimed in claim 11, wherein said rechargeable battery is connected to electrically-conductive contacts disposed on said end cap.

13. The device as claimed in claim 1 further comprising a stand for holding said device.

14. The device as claimed in claim 13, wherein said stand houses a conventional, AC battery charger for charging said rechargeable battery.

15. The device as claimed in claim 14, wherein said stand holds said device in a vertical orientation such that said electrically-conductive contacts disposed on said end cap are engaged by and in electrical contact with like contacts disposed on said stand.

16. The device as claimed in claim 14, wherein said battery charger, when connected to an AC power line, recharges said battery in said device when said device is placed in said stand.
